(19) United States
(12) Patent Application Publication
(10) Pub. No.: US 2014/0076678 A1
(43) Pub. Date: Mar. 20, 2014

(54) MACHINE-TOOL BRAKING DEVICE

(71) Applicants: Joachim Schadow, Stuttgart (DE); Manfred Lutz, Filderstadt (DE); Juergen Wiker, Mount Prospect, IL (US); Joerg Maute, Sindelfingen (DE); Florian Esenwein, Leinfelden-Echterdingen (DE)

(72) Inventors: Joachim Schadow, Stuttgart (DE); Manfred Lutz, Filderstadt (DE); Juergen Wiker, Mount Prospect, IL (US); Joerg Maute, Sindelfingen (DE); Florian Esenwein, Leinfelden-Echterdingen (DE)

(73) Assignee: Robert Bosch GmbH, Stuttgart (DE)

(21) Appl. No.: 14/115,519

(22) PCT Filed: Mar. 12, 2012
(86) PCT No.: PCT/EP2012/054187

§ 371 Date: Nov. 4, 2013

(30) Foreign Application Priority Data
May 4, 2011 (DE) 10 2011 075 222.6

(51) Int. Cl. B24B 23/02; F16D 49/08

(52) U.S. Cl. CPC B24B 23/028; F16D 49/08
USPC 188/77 W

(57) ABSTRACT

A machine-tool braking device, particularly a hand-held machine-tool braking device, for a portable machine-tool includes at least one mechanical braking unit that has at least one braking element and at least one output unit that has at least one movably mounted output element. The braking element is formed by an encircling mechanism which at least partially encircles the output element in a state of operation.

### BACKGROUND OF THE INVENTION

Machine-tool braking devices, especially hand-held machine-tool braking devices, of a portable machine tool, which have a mechanical brake unit with a braking element and an output unit with a movably mounted output element, are already known.

### DISCLOSURE OF THE INVENTION

The invention starts from a machine-tool braking device, especially from a hand-held machine-tool braking device, of a portable machine tool, with at least a mechanical brake unit, which has at least a braking element, and with at least a drive unit, which has at least a movably mounted output element.

It is proposed that the braking element is formed by a wrap-around means which at least partially wraps around the output element at least in an operating state. Especially a machine tool, especially a hand-held machine tool, which can be transported by an operator without a transporting machine, is to be understood here by a “portable machine tool”. The portable machine tool especially has a mass which is less than kg, preferably less than 20 kg and especially preferably less than 10 kg. The term “mechanical brake unit” is to define here especially a brake unit which is provided for transferring at least the braking element of the brake unit into a braking position and/or into a released position, especially decoupled from a magnetic force, as a result of a mechanical operation, especially as a result of an exertion of a force of a component upon the braking element by means of a direct contact between the component and the braking element. Especially specifically designed and/or specifically equipped is to be understood by “provided”. A position of the braking element in which at least a braking force for a reduction of a speed within a predetermined time period, especially by at least more than 50%, preferably at least more than 65% and especially preferably by at least more then 80%, of a moving component is exerted upon said moving component in at least an operating state, is to be understood here by a “braking position”. In this case, the predetermined time period is especially less than 5 sec. The term “released position” is to define here especially a position of the braking element in which an effect of the braking force for a reduction of the speed upon the moving component is at least in the main prevented. The mechanical brake unit is preferably provided for braking the component especially within a predetermined time period of more than 0.1 sec., preferably of more than 0.5 sec., and especially preferably of less than 3 sec, starting from an operating speed, especially for braking to a speed which is less than 50% of the operating speed, preferably less than 20% of the operating speed and especially preferably for braking to a speed of 0 m/s. The mechanical brake unit is advantageously designed as a friction brake.

Especially a unit which by means of a drive unit of the portable machine tool can be driven and transmits forces and/or torque generated by the drive unit to a machining tool, is to be understood here as an “output unit”. In this case, the output element is preferably rotatably mounted. The output unit is preferably designed as an angle gear. Especially a gear which has an output shaft which is arranged at an angle relative to an input shaft, the rotational axes of the input shaft and the output shaft preferably having a common point of intersection, is to be understood here by “angle gear”. Especially an arrangement of one axis relative to another axis, especially of two intersecting axes, the two axes including an angle which differs from 180°, is to be understood here by “arranged at an angle”. A rotational axis of the input shaft and a rotational axis of the output shaft, in an assembled state of the output unit in the form of an angle gear, preferably include an angle of 90°.Especially a shaft which introduces forces and/or torque into the output unit, in the form of an angle gear, is to be understood here by an “input shaft”. Especially a shaft, especially a spindle, of the output unit, which transmits forces and/or torque to a machining tool, for example, which is connected in a rotation-resistant manner to the output shaft, is to be understood here by an “output shaft”. The output element is preferably designed as a gear wheel. Especially preferably, the output element is designed in this case as a bevel gear.

Especially a component which with an action of forces of less than 10 N, preferably less than 1 N and especially preferably less than 0.5 N is deformable, especially elastically deformable, at least in the main transversely at least to a longitudinal axis of the component, is to be understood here by a “wrap-around means”. The wrap-around means can be formed in this case by a cable, a belt and/or by another wrap-around means which appears to be practical to a person skilled in the art. The term “at least partially wrap around” is to define here especially an arrangement of the braking element relative to the output element, wherein the braking element, at least in an operating state along an angular range which is greater than 90°, especially as a result of an elastic deformation of the braking element, especially directly, bears on a circumference of the output element. The circumference of the output element especially extends along a circumferential direction which extends in a plane which extends at least in the main perpendicularly to a rotational axis of the output element. By means of the embodiment of the machine-tool braking device according to the invention, an installation space-saving braking device can advantageously be achieved. Furthermore, a braking force for a braking of the moving output element of the output unit can be created in a constructionally simple manner.

Furthermore, it is proposed that the braking element has an angle of wrap which is greater than 180°. The term “angle of wrap” is to define here especially a contact region in angular degrees in which the braking element encompasses the output element and bears directly on a circumference of the output element. The braking element preferably has an angle of wrap which is greater than 200° and especially preferably greater than 220°. A large friction surface between the braking element and the output element can advantageously be achieved. As a result of this, a short braking time can especially advantageously be achieved.

The machine-tool braking device advantageously comprises at least an operating unit for activating and/or for deactivating the brake unit with at least a cam gear element which, for altering a distance between the braking element and the output element, acts at least upon one end of the braking element. Especially a unit which is provided for altering a state of a unit which is superordinate to the operating unit as a result of an operation at least of an operating element is to be understood here by “operating unit”. The operating unit, in addition to activating and/or in addition to deactivating the mechanical brake unit, is especially preferably provided for enabling and/or for disconnecting a power supply of a drive unit as a result of an operation of an operating element of the operating unit. With an activation of the brake unit by means of the operating unit, the braking element is preferably transferred into a braking position. With a deactivation of the brake unit by means of the operating unit, the braking element is preferably transferred into a released position. The operating element is preferably designed as a slide switch. It is also conceivable, however, that the operating element has another design which appears to be practical to a person skilled in the art, such as a design as a toggle switch. The operating element preferably has a movement axis which extends at least in the main parallel to a rotational axis of an armature shaft of the drive unit of the portable machine tool. An element which is provided for altering a type of movement, such as a translation and/or a rotation, and/or a movement direction, especially by means of an interaction with another element, is to be understood here by a “cam gear”. In this case, the cam gear element can be designed for example as a ramp, which interacts with another component for a conversion of movement, as a pin or groove, which interacts with a groove or with a pin, and/or as another component which appears to be practical to a person skilled in the art. A releasing of the wrap of the braking element can advantageously be achieved. Furthermore, the braking element can be transferred from a braking position into a released position in a constructionally simple manner.

Furthermore, it is proposed that the cam gear element is mounted in a translationally movable manner. The cam gear element is preferably fixed on the operating element by means of a form-fitting connection, for example a latching connection. It is also conceivable, however, that the cam gear element is fixed on the operating element by means of a form-fitting connection and/or by means of a materially bonding connection. Moreover, it is conceivable that the cam gear element, for example in an alternative embodiment of the machine-tool braking device, is arranged on an air-guiding element and can be set in rotation, wherein the rotation of the cam gear element, by means of an interaction of a ramp or the like, operates the end of the braking element for loosening and/or tensioning of the braking element. By means of the translational mounting of the cam gear element, a compact operating unit can advantageously be achieved.

The brake unit preferably has at least a spring element which is provided for acting upon the braking element with a spring force at least in one operating state. Especially a “macroscopic element” which has at least an extent which in a normal operating state can be elastically varied by at least 10%, especially by at least 20%, preferably by at least 30% and especially advantageously by at least 50%, and which especially creates a counter force which is dependent upon a variation of the extent and is preferably proportional to the variation, and counteracts the variation, is to be understood by a “spring element”. Especially a maximum distance between two points of a perpendicular projection of the element on one plane is to be understood by an “extent of an element”. Especially an element with an extent of at least 1 mm, especially of at least 5 mm and preferably of at least 10 mm, is to be understood by a “macroscopic element”. The spring element is preferably provided for pretensioning the braking element. Therefore, bearing of the braking element on the output element can advantageously be ensured at least in an operating state. Furthermore, an automatic return of the counter braking element into a braking position can advantageously be achieved at least in an operating state.

Moreover, it is proposed that the braking element is designed as a band. The band preferably has an extent along a longitudinal axis which is greater by a multiple than along a direction which extends at least in the main perpendicularly to the longitudinal axis. The band is preferably of an elastically deformable design. The band is advantageously formed from a metal material. It is also conceivable, however, that the band is formed from a composite material and/or from another material which appears to be practical to a person skilled in the art. As a result of the design of the braking element as a band, an advantageously compact and installation space-saving braking element can be achieved.

Furthermore, it is proposed that the brake unit has at least a brake lining which is arranged on the output element at least partially along a circumference of said output element. Especially an element which is provided for increasing a friction coefficient of a friction pair in comparison to a friction coefficient of a friction pair which is decoupled from a friction lining, especially a friction pair between the braking element and the output element, is to be understood here by a “brake lining”. The brake lining can be fixed on the output element by means of a form-fitting connection, frictional connection and/or materially bonding connection, such as an adhesive bond, a riveted connection, a screwed connection or a connection which has been created by means of a sintering process or by means of a spraying process, etc. The brake lining in this case can be designed as a sintered brake lining, as an organic brake lining, as a brake lining consisting of carbon, as a brake lining consisting of ceramic, or as another brake lining which appears to be practical to the person skilled in the art. A high braking force can advantageously be achieved. As a result of this, braking time can advantageously be minimized.

Moreover, it is proposed that the brake lining is arranged in at least one recess of the output element. The output element especially preferably has at least four recesses which are arranged in a uniformly distributed manner along the circumference of the output element, as seen along a circumferential direction, and in which a brake lining is arranged in each case. It is also conceivable, however, that the output element has a number of recesses which differs from four, in which a brake lining of the brake unit is arranged in each case. Shear forces and/or thrust forces of the braking element can be transmitted in an especially advantageous manner.

Furthermore, the invention is based on a portable machine tool with at least a machine-tool braking device according to the invention. The portable machine tool is especially preferably designed as an angle grinding machine. It is also conceivable, however, that the portable machine tool has another design which appears to be practical to the person skilled in the art, such as a hand-held planing machine, as a multifunction machine tool, as a portable milling machining, as a grinding machine, and/or as an electrically operable gardening implement. A higher operating comfort for an operator of the portable machine tool can advantageously be achieved.

The machine-tool braking device according to the invention is not limited in this case to the application and embodiment described above. The machine-tool braking device according to the invention, for fulfilling a principle of operation described herein, can especially have a number of individual elements, components, devices and units which differ from a number referred to herein.

### DRAWING

Further advantages are to be gathered from the following drawing description. Shown in the drawing are exemplary embodiments of the invention. The drawing, the description and the claims contain numerous features in combination. The person skilled in the art will consider the features expediently and also individually and group them to form practical further combinations.

In the drawing:

FIG. 1 shows in a schematic representation a portable machine tool according to the invention with a machine-tool braking device according to the invention,

FIG. 2 shows in a schematic representation a detailed view of the machine-tool braking device according to the invention in an installed state in a housing of the portable machine tool according to the invention,

FIG. 3 shows in a schematic representation a further detailed view of the machine-tool braking device according to the invention in an installed state in a housing of the portable machine tool according to the invention, and

FIG. 4 shows in a schematic representation a detailed view of an alternative machine-tool braking device according to the invention in an installed state in a housing of a portable machine tool according to the invention.

### DESCRIPTION OF THE EXEMPLARY EMBODIMENTS

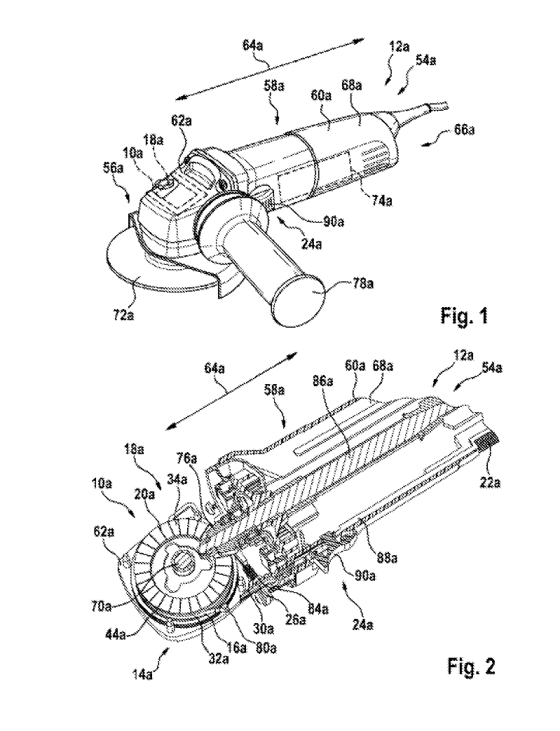

FIG. 1 shows a portable machine tool 12a in the form of an angle grinding machine 54a with a machine-tool braking device 10a. The angle grinding machine 54a comprises a protective hood unit 56a, a machine tool housing 58a and a main handle 60a. The main handle 60a extends from a gear housing 62a of the machine tool housing 58a in a direction which faces away from the gear housing 62a and extends at least in the main parallel to a main direction of extent 64a of the angle grinding machine 54a up to a side 66a of the machine tool housing 58a on which is arranged a cable of the angle grinding machine 54a for power supply. The main handle 60a forms a motor housing 68a of the machine tool housing 58a. Extending from the gear housing 62a is a spindle 70a (FIG. 2) on which a machining tool 72a can be fixed for machining a workpiece (not shown in more detail here). The machining tool 72a is designed as a grinding disk. It is also conceivable, however, that the machining tool 72a is designed as a cutting disk or polishing disk. The machine tool housing 58a comprises a motor housing 68a for accommodating a drive unit 74a of the angle grinding machine 54a, and the gear housing 62a for accommodating an output unit 18a of the machine-tool braking device 10a. The drive unit 74a is provided for rotationally driving the machining tool 72a via the output unit 18a. The output unit 18a is connected to the drive unit 76a via a rotationally drivable drive element 76a of the drive unit 74a (FIG. 2) in a way already known to the person skilled in the art. An additional handle 78a is arranged on the gear housing 62a. The additional handle 78a extends transversely to the main direction of extent 64a of the angle grinding machine 54a.

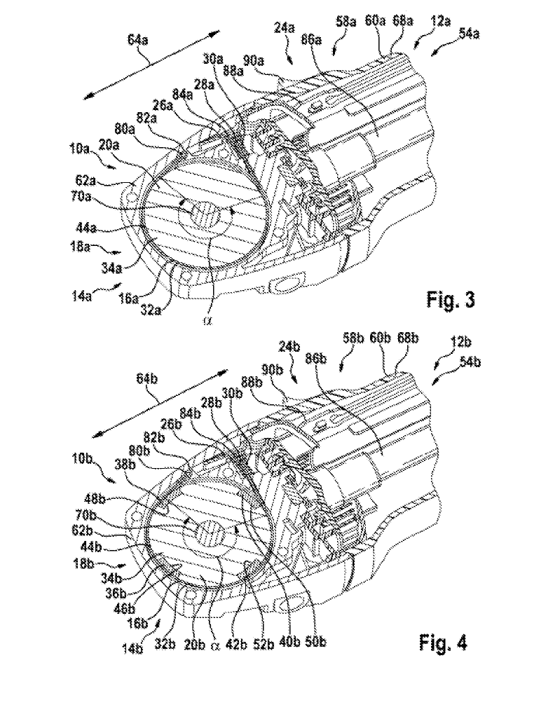

FIG. 2 shows a detailed view of the machine-tool braking device 10a in an installed state in the machine tool housing 58a of the angle grinding machine 54a. The machine-tool braking device 10a of the portable machine tool 12a, in the form of an angle grinding machine 54a, comprises a mechanical brake unit 14a which has a braking element 16a. Furthermore, the machine-tool braking device 10a comprises the output unit 18a which has a movably mounted output element 20a. The output element 20a is designed as a bevel gear 34a. The bevel gear 34a is mounted in a rotation-resistant manner on the spindle 70a which is rotatably mounted in the gear housing 62a. The braking element 16a is formed by a wrap-around means which partially wraps around the output element 20a at least in an operating state. In this case, the braking element 16a is designed as a band 32a. The braking element 16a, in the form of a band 32a, has an angle of wrap a which is greater than 180°. In a braking position of the braking element 16a, the braking element 16a wraps around the bevel gear 34a with an angle of wrap a of about 240° (FIG. 3). As a result of the wrapping around of the bevel gear 34a by means of the band 32a, a frictional engagement is created between the bevel gear 34a and the band 32a.

The braking element 16a, in the form, of a band 32a is arranged in the gear housing 62a between an inner wall of the gear housing 62a which faces the bevel gear 34a and the bevel gear 34a, as seen along a direction which extends at least in the main perpendicularly to a rotational axis of the bevel gear 34a. In this case, the braking element 16a has a fixing section 80a by means of which the braking element 16a is fixed in the gear housing 62a. The fixing section 80a is designed in the form of a loop and is fixed in the gear housing 62a by means of a fastening element 82a of said gear housing 62a (FIG. 3). The fastening element 82a is designed as a recess which is formed to correspond to the fixing section 80a. Therefore, the braking element 16a, by an interaction of the fixing section 80a and the fastening element 82a, is fixed in the gear housing 62a in a form-fitting manner. It is also conceivable, however, that the fastening element 82a has another design which appears to be practical to the person skilled in the art, such as a design as a bolt which extends in and/or through the fixing section 80a and fixes the braking element 16a. The fixing section 80a, in an installed state of the braking element 16a, is arranged along the direction which extends at least in the main perpendicularly to the rotational axis of the bevel gear 34a at a distance relative to said bevel gear 34a.

Furthermore, the machine-tool braking device 10a comprises an operating unit 24a for activating and/or for deactivating the brake unit 14a with at least a cam gear element 26a which, for altering a distance between the braking element 16a and the output element 20a, acts at least upon one end 28a of the braking element 16a. The end 28a is movably mounted in the gear housing 62a. Furthermore, the end 28a is arranged on a side of the braking element 16a which faces away from the fixing section, as seen along a longitudinal axis of said braking element 16a. On the end 28a, the braking element 16a has an operating section 84a. The operating section 84a is of a cylindrical design. A circular base surface of the cylindrical operating section 84a faces the cam gear element 26a. The cam gear element 26a in this case bears on the base surface. The cam gear element 26a is provided for operation of the operating section 84a. The operating section 84a is fixed on the end 28a by means of a frictional connection, such as by means of a pressed fit. It is also conceivable, however, that the operating section 84a is fixed on the end 28a of the braking element 16a by means of a form-fitting connection and/or by means of a materially bonding connection.

The brake unit 14a also has a spring element 30a which is provided for acting upon the braking element 16a with a spring force, at least in an operating state. The spring element 30a is designed as a compression spring. In this case, the compression spring is designed as a helical spring. It is also conceivable, however, that the spring element 30a has another design which appears to be practical to the person skilled in the art, such as an extension spring, a disk spring, a volute spring, etc. The spring element 30a is arranged in this case between the operating section 84a and the gear housing 62a. Therefore, the spring element 30a is supported by one end on the gear housing 62a and supported by another end on the operating section 84a. The spring element 30a is therefore provided for acting upon the operating section 84a with a spring force in the direction of the cam gear element 26a.

The cam gear element 26a is mounted in a translationally movable manner. In this case, a movement axis of the cam gear element 26a extends at least in the main parallel to a rotational axis of an armature shaft 86a of the drive unit 74a (FIG. 3). The cam gear element 26a is of a ramp-like design. It is also conceivable, however, that the cam gear element 26a has another design which appears to be practical to the person skilled in the art. The cam gear element 26a is provided for sliding on the base surface of the operating section 84a during a movement of said cam gear element 26a. The cam gear element 26a and/or the base surface of the operating section 84a can be provided in this case with a coating, such as a layer of Teflon, for minimizing friction. The operating section 84a, as a result of an interaction with the cam gear element 26a, is moved against a spring force of the spring element 30a in dependence upon the position of said cam gear element 26a. The cam gear element 26a is formed in this case in one piece with an operating rod 88a of the operating unit 24a. The operating rod 88a is fixed on an operating element 90a of the operating unit 24a which is movably mounted in a recess of the motor housing 68a. The operating rod 88a, moreover, is provided for operating a switch (not shown in more detail here) which disconnects and/or closes an electric circuit for a power supply of the drive unit 74a. The cam gear element 26a is formed onto the operating rod 88a on a side of the operating rod 88a which faces away from the switch. The operating unit 24a is therefore provided for operating a switch for the power supply of the drive unit 74a and additionally for activating and/or deactivating the brake unit 16a by means of the cam gear element 26a. For ensuring a movement of the operating rod 88a and therefore of the cam gear element 26a in a direction which faces away from the gear housing 62a, the operating rod 88a is acted upon by a spring force by means of a return spring element 22a of the operating unit 24a in the direction which faces away from the gear housing 62a. The operating rod 88a extends from the motor housing 68a into the gear housing 62a. In this case, the operating rod 88a extends through a sealing element (not shown in more detail here) of the machine-tool braking device 10a, which sealing element is provided for preventing an escape of lubricant from the gear housing 62a into the motor housing 68a and/or to prevent an entry of dirt into the gear housing 62a. It is also conceivable, however, that the operating rod 88a is of a multipiece design and the forces for movement of the cam gear element 26a are transmitted by means of a membrane. Other designs for preventing an escape of lubricant from the gear housing 62a and/or an entry of dirt into the gear housing 62a are also conceivable.

For starting up the angle grinding machine 54a, the operating element 90a of the operating unit 24a is activated by an operator. In this case, the operator displaces the operating element 90a in a translational manner from an initial position into the recess of the motor housing 68a in the direction of the gear housing 62a. As a result of the translational movement of the operating element 90a in the direction of the gear housing 62a, the operating rod 88a, which is fixed on the operating element 90a, is also moved in the direction of the gear housing 62a against a spring force of the return spring element 22a. The cam gear element 26a is therefore displaced on the base surface of the operating section 84a. As a result of this, the operating section 84a and therefore the end 28a of the braking element 16a are displaced against a spring force of the spring element 30a in the direction of output element 20a which is in the form of a bevel gear 34a. The spring element 30a is therefore compressed. The braking element 16a, in the form of a band 32a, is relaxed as a result of the movement of the operating section 84a and moved away from a circumference 44a of the bevel gear 34a. As a result of this, the distance between the braking element 16a, in the form of a band 32a, and the output element 20a, in the form of a bevel gear 34a, is altered. Consequently, the frictional engagement between the braking element 16a, in the form of a band 32a, and the output element 20a, in the form of a bevel gear 34a, is lifted. The braking element 16a has been transferred into a released position. In this case, the braking element 16a, in an end position of the operating element 90a, is free of contact with the circumference 44a of the output element 20a in the form of a bevel gear 34a. The circumference 44a extends along a circumferential direction which extends in a plane which extends at least in the main perpendicularly to the rotational axis of the output element 20a. In the end position of the operating element 90a, moreover, the electric circuit for the power supply of the drive unit 74a is closed by means of an operation of the switch by means of the operating rod 88a. It is also conceivable, however, that the electric circuit is closed before the end position of the operating element 90a is reached in order to enable starting of the drive unit 74a under a low braking load for a smooth start. The output element 20a, as result of the lifting of the frictional engagement between the braking element 16a and the output element 20a, can exert a rotational movement around the rotational axis as a result of a drive by means of the drive unit 74a in order to enable machining of a workpiece (not shown in more detail here) with the angle grinding machine 54a by means of the machining tool 72a.

For interrupting an operation of the angle grinding machine 54a, the operating element 90a is moved from the end position by the operator in a translational manner in the direction which faces away from the gear housing 62a. As a result of this, the operating rod 88a and the cam gear element 26a are also moved in the direction which faces away from the gear housing 62a. The movement is assisted in this case by means of the return spring element 22a. An operation of the switch by means of the operating rod 88a is terminated and an electric circuit for the power supply of the drive unit 74a is disconnected. The cam gear element 26a, during the movement, slides on the base surface of the operating section 84a in the direction which faces away from the gear housing 62a. The operating section 84a is moved in the direction of the cam gear element 26a as a result of a spring force of the spring element 30a. The further the operating rod 88a is moved out of the gear housing 62a, the more the braking element 16a is tensioned as a result of the interaction of the ramp-like cam gear element 26a and the base surface of the operating section 84a. As a result of this, the braking element 16a is moved in the direction of the circumference 44a of the bevel gear 34a until the braking element 16a bears on the circumference 44a. Therefore, the braking element 16a is transferred into a braking position of said braking element 16a. In this case, the braking element 16a wraps around the drive element 20a, in the form of a bevel gear 34a, with an angle of wrap of about 260°. A frictional engagement, which brakes the output element 20a during a rundown, is created between the braking element 16a and the output element 20a.

Shown in FIG. 4 is an alternative exemplary embodiment. In the main, similar components, features and functions are basically numbered with the same designations. For differentiating between the exemplary embodiments, the letters a and b are added to the designations of the exemplary embodiments. The following description is basically limited to the differences to the first exemplary embodiment in FIGS. 1 to 3, wherein with regard to similar components, features and functions reference can be made to the description of the first exemplary embodiment in FIGS. 1 to 3.

FIG. 4 shows a detailed view of an alternative machine-tool braking device 10b in an installed state in a housing 58b of a portable machine tool 12b which is designed as an angle grinding machine 54b. The angle grinding machine 54b has a construction which corresponds to the angle grinding machine 54a which is described in FIGS. 1 to 3. The machine-tool braking device 10b of the portable machine tool 12b in the form of an angle grinding machine 54b comprises a mechanical brake unit 14a which has a braking element 16a. Furthermore, the machine-tool braking device 10b comprises an output unit 18b which has a movably mounted output element 20b. The output element 20b is designed as a bevel gear 34b. The braking element 16b is formed by a wrap-around means which partially wraps around the output element 20b at least in an operating state. In this case, the braking element 16b is designed as a band 32b.

The brake unit 14b also has four brake linings 36b, 38b, 40b, 42b which are arranged on the output element 20b partially along a circumference 44b. The output element 20b has four recesses 46b, 48b, 50b, 52b which are distributed uniformly along the circumference 44b along a circumferential direction which extends in a plane which extends at least in the main perpendicularly to a rotational axis of the output element 20b. The brake linings 36b, 38b, 40b, 42b are arranged in the recesses 46b, 48b, 50, 52b of the output element 20b. The brake linings 36b, 38b, 40b, 42b are arranged in the region of the recesses between the braking element 16b and the output element 20b, as seen along a direction which at least in the main extends perpendicularly to the rotational axis of the output element 20b. With regard to a principle of operation and additional components, units and devices of the machine-tool braking device 10b which are relevant to the principle of operation, reference may be made to a principle of operation which is described in FIGS. 1 to 3.

1. A machine-tool braking device of a portable machine tool, comprising:
at least a mechanical brake unit having at least a braking element; and
at least an output unit having at least a movably mounted output element,
wherein the braking element is formed by a wrap-around mechanism that at least partially wraps around the output element at least in an operating state.

2. The machine-tool braking device as claimed in claim 1, wherein the braking element has an angle of wrap which is greater than 180°.

3. The machine-tool braking device as claimed in claim 1, further comprising at least an operating unit configured to one or more of activate and deactivate the brake unit with at least a cam gear element, the cam gear element being configured to act at least upon one end of the braking element so as to alter a distance between the braking element and the output element.

4. The machine-tool braking device as claimed in claim 3, wherein the cam gear element is mounted in a translationally movable manner.

5. The machine-tool braking device as claimed in claim 1, wherein the brake unit has at least a spring element configured to act upon the braking element with a spring force at least in an operating state.

6. The machine-tool braking device as claimed in claim 1, wherein the braking element is configured as a band.

7. The machine-tool braking device as claimed in claim 1, wherein the output element is configured as a bevel gear.

8. The machine-tool braking device as claimed in claim 1, wherein the brake unit has at least one brake lining arranged on the output element at least partially along a circumference of said output element.

9. The machine-tool braking device as claimed in claim 8, wherein the brake lining is arranged in at least one recess of the output element.

10. A portable machine tool, comprising:
at least a machine-tool braking device including:
at least a mechanical brake unit having at least a braking element; and
at least an output unit having at least a movably mounted output element,
wherein the braking element is formed by a wrap-around mechanism that at least partially wraps around the output element at least in an operating state.

11. The machine-tool braking device as claimed in claim 1, wherein the machine-tool braking device is configured as a hand-held machine-tool braking device.

12. The portable machine tool as claimed in claim 10, wherein the portable machine tool is configured as an angle grinding machine.
